(19) United States
(12) Patent Application Publication
(10) Pub. No.: US 2026/0313720 A1
(43) Pub. Date: Oct. 8, 2026

(54) INFORMATION PROCESSING SYSTEM, COMMUNICATION DEVICE, AND PROCESSING METHOD

(71) Applicant: SEIKO EPSON CORPORATION, Tokyo (JP)

(72) Inventor: Kota NISHIDA, Shiojiri (JP)

(21) Appl. No.: 19/461,961

(22) Filed: Jan. 28, 2026

(30) Foreign Application Priority Data
Jan. 30, 2025 (JP) 2025-013730

(51) Int. Cl. H04W 76/10; H04B 17/318; H04W 12/50

(52) U.S. Cl. CPC H04W 76/10; H04B 17/318; H04W 12/50

(57) ABSTRACT

A communication device according to an aspect of the present disclosure includes a WF wireless communication section that performs communication according to a first wireless communication standard, a BT wireless communication section that performs communication according to a second wireless communication standard, a UI section (printing section) that presents information, a determination section that determines whether a strength of a signal received from a terminal device is equal to or more than a predetermined threshold, and a wireless setting section that, when it is determined that the strength is equal to or more than the threshold, causes the UI section (printing section) to present predetermined information, and that, when it is determined that the strength is less than the threshold, causes the BT wireless communication section to transmit the predetermined information.

### CROSS REFERENCE TO RELATED APPLICATION

The present application is based on, and claims priority from JP Application Serial Number 2025-013730, filed Jan. 30, 2025, the disclosure of which is hereby incorporated by reference herein in its entirety.

### BACKGROUND

### 1. Technical Field

The present disclosure relates to an information processing system, a communication device, and a processing method.

### 2. Related Art

A function called Wi-Fi Easy Connect (registered trademark) formulated by Wi-Fi Alliance is known. This function is a technique in which an apparatus called a Configurator provides access point information to an apparatus called an Enrollee according to a Device Provisioning Protocol (DPP). As a result, the enrollee that has acquired the access point information can wirelessly connect to the access point.

In this regard, JP-A-2019-205021 discloses that DPP is used to wirelessly connect a printing device to an access point.

In the technique disclosed in JP-A-2019-205021, in Bootstrapping performed as a first phase of the DPP, the printing device displays a code image (specifically, a QR code (registered trademark)) on a display section. When the user operates the terminal device to cause the terminal device to read the code image, information such as a public key is provided from the printing device as an enrollee to the terminal device as a configurator. As another method of providing the public key or the like from the enrollee to the configurator in Bootstrapping, there is a method of transmitting the public key or the like from the enrollee to the configurator by using communication according to the Bluetooth (registered trademark) standard. However, in the case of information transmission by communication using Bluetooth, the processing proceeds by information transmission by invisible radio waves, and the user does not understand the progress status. Therefore, information transmission by reading a code image may be preferred, which requires a user's own proactive operation. In addition, in recent years, QR codes have become popular, and there are more opportunities for users to capture QR codes using smartphones and the like. Therefore, since the operation of capturing the QR code is familiar to the user, information transmission by the code image is also preferable from the user-friendly point of view.

However, in the case of information transmission by reading the code image, the user needs to carry the terminal device and move close to the device as the enrollee in order to read the code image. Therefore, when the distance from the user's position to the device for which the wireless connection is to be set is long, the user has to move a lot. Therefore, in such a case, there is a problem that the user is burdened by the need for information transmission using the code image at the time of wireless setting.

### SUMMARY

According to an aspect of the present disclosure, there is provided an information processing system including: a communication device; and a terminal device carried by a user and configured to send a signal according to a predetermined wireless communication standard in response to an instruction from the user, in which the communication device includes a first wireless communication section that performs communication according to a first wireless communication standard, second wireless communication section that performs communication according to a second wireless communication standard which is the predetermined wireless communication standard, a presentation section that presents information, a determination section that determines whether a strength of the signal received by the second wireless communication section from the terminal device is equal to or more than a predetermined threshold, and a wireless setting section that, when it is determined that the strength is equal to or more than the threshold, causes the presentation section to present predetermined information, and, when it is determined that the strength is less than the threshold, causes the second wireless communication section to transmit the predetermined information, and the predetermined information is information that is required to be provided to the terminal device in order for the terminal device to start communication according to a predetermined communication procedure for the first wireless communication section to receive access point information which is information used to establish a wireless communication connection between an access point and the first wireless communication section from the terminal device.

According to an aspect of the present disclosure, there is provided a communication device including: a first wireless communication section that performs communication according to a first wireless communication standard; a second wireless communication section that performs communication according to a second wireless communication standard; a presentation section that presents information; a determination section that determines whether a strength of a signal received by the second wireless communication section from a terminal device carried by a user is equal to or more than a predetermined threshold; and a wireless setting section that, when it is determined that the strength is equal to or more than the threshold, causes the presentation section to present predetermined information, and, when it is determined that the strength is less than the threshold, causes the second wireless communication section to transmit the predetermined information, in which the predetermined information is information that is required to be provided to the terminal device in order for the terminal device to start communication according to a predetermined communication procedure for the first wireless communication section to receive access point information, which is information used to establish a wireless communication connection between an access point and the first wireless communication section, from the terminal device.

According to an aspect of the present disclosure, there is provided a processing method for a communication device including a first wireless communication section that performs communication according to a first wireless communication standard, a second wireless communication section that performs communication according to a second wireless communication standard, and a presentation section that presents information, the method including: determining whether a strength of a signal received from a terminal device carried by a user by the second wireless communication section is equal to or more than a predetermined threshold; when it is determined that the strength is equal to or more than the threshold, causing the presentation section to present predetermined information; and when it is determined that the strength is less than the threshold, causing the second wireless communication section to transmit the predetermined information, in which the predetermined information is information that is required to be provided to the terminal device in order for the terminal device to start communication according to a predetermined communication procedure for the first wireless communication section to receive access point information, which is information used to establish a wireless communication connection between an access point and the first wireless communication section, from the terminal device.

### BRIEF DESCRIPTION OF THE DRAWINGS

FIG. 1 is a schematic diagram illustrating a configuration example of an information processing system including a communication device and a terminal device.

FIG. 2 is a block diagram illustrating an example of a configuration of the communication device.

FIG. 3 is a block diagram illustrating an example of a configuration of the terminal device.

FIG. 4 is a sequence chart illustrating an example of a flow of processing until Bootstrapping information is provided.

FIG. 5 is a flowchart illustrating a flow of transition of a UI screen displayed on the terminal device.

FIG. 6 is a schematic diagram illustrating an example of an instruction acceptance screen.

FIG. 7 is a schematic diagram illustrating an example of a standby screen.

FIG. 8 is a schematic diagram illustrating an example of a start notification screen.

FIG. 9 is a schematic diagram illustrating an example of a reading request screen.

FIG. 10 is a sequence chart illustrating an example of a flow of an operation of the communication device establishing wireless connection with an access point.

FIG. 11 is a sequence chart illustrating an example of a flow of processing until the communication device provides the Bootstrapping information in a modification example.

FIG. 12 is a table summarizing a relationship between the determination result and the method of determining the Bootstrapping.

FIG. 13 is a block diagram illustrating an example of a hardware configuration of a computer included in the communication device, the terminal device, or the access point.

### DESCRIPTION OF EMBODIMENTS

Hereinafter, embodiments and the like will be described with reference to the drawings. For clarification of the description, the following description and drawings are appropriately omitted and simplified. In each drawing, the same elements will be given the same reference numerals, and the redundant description thereof will be omitted as necessary. In addition, not all of the features or steps illustrated in any one of the drawings for describing the exemplary embodiment are necessarily required, and some of the features or steps may be omitted. Further, the order of the steps described in any of the drawings may be appropriately changed.

### Embodiment

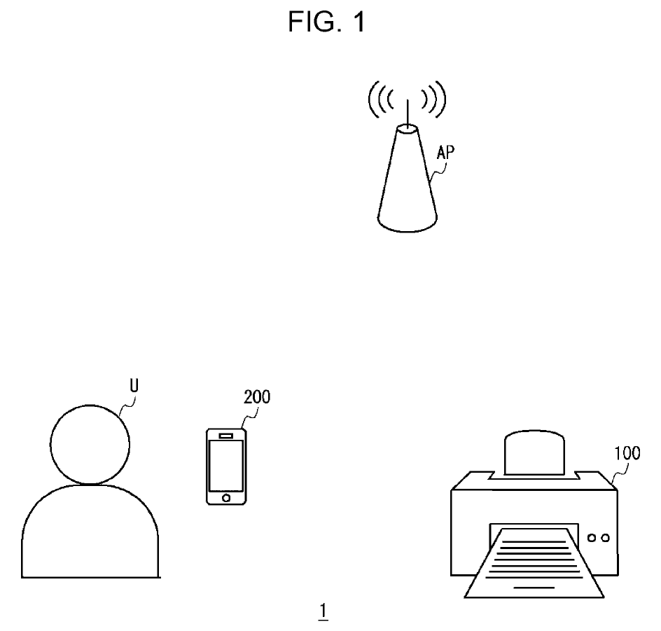

FIG. 1 is a schematic diagram illustrating a configuration example of an information processing system 1 including a communication device 100 and a terminal device 200 according to an embodiment. As illustrated in FIG. 1, the information processing system 1 may further include an access point AP. The communication device 100 and the access point AP are devices installed at predetermined locations, whereas the terminal device 200 is a device carried by a user U and can move with the user U.

In the present embodiment, the communication device 100, the terminal device 200, and the access point AP are devices provided with a Wi-Fi Easy Connect function. In the present embodiment, the terminal device 200 is a device having access point information. The terminal device 200 may be a terminal that has already established wireless communication connection with the access point AP. Meanwhile, the communication device 100 is a device that does not yet have the access point information. That is, the communication device 100 is a device that has not yet established a wireless communication connection with the access point AP. Here, the access point information is information required to establish wireless communication connection with the access point AP. Specifically, the access point information is information referred to as a “Configuration Object” in a DPP. The access point information may include, for example, at least one of a Service Set Identifier (SSID) and a password of the access point AP. However, the access point information may be any information required to establish wireless communication connection with the access point AP, and may include other information in addition to the SSID or the password, or together with the SSID or the password. Specifically, the access point AP is, for example, a wireless Local Area Network (LAN) router or the like.

In the present embodiment, the access point information is transmitted from the terminal device 200 to the communication device 100 according to the procedure defined by the DPP. As a result, the communication device 100 can establish wireless communication connection with the access point AP. In the present embodiment, the terminal device 200 operates as a Configurator defined in the DPP, and the communication device 100 operates as an Enrollee defined in the DPP.

In the present embodiment, the communication device 100 is a printer that prints information on a medium such as paper, but the communication device 100 may be any device having a communication function, and does not necessarily have to be a printer.

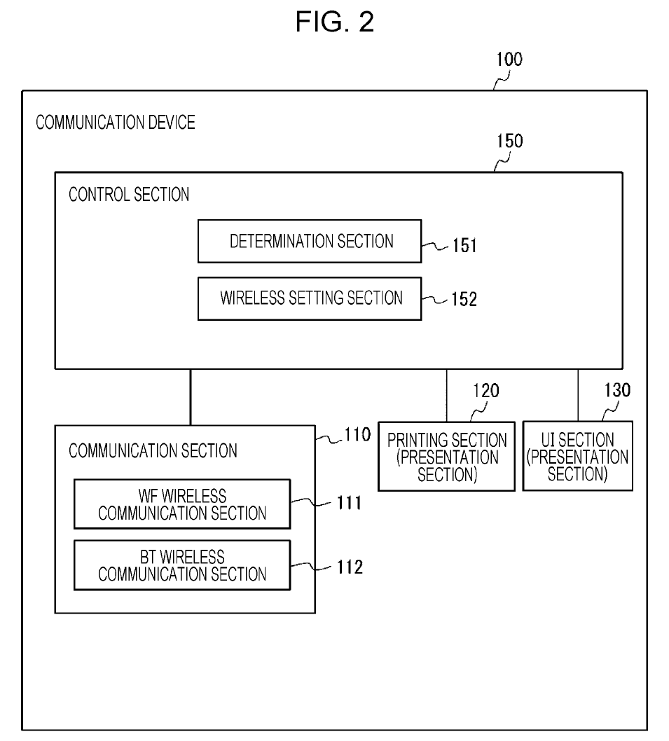

FIG. 2 is a block diagram illustrating an example of a configuration of the communication device 100. As illustrated in FIG. 2, the communication device 100 includes a communication section 110, a printing section 120, a user interface (UI) section 130, and a control section 150.

The communication section 110 is a hardware circuit that performs wireless communication according to a predetermined communication standard with another device, and may include software such as firmware. The communication section 110 includes a WF wireless communication section 111 and a BT wireless communication section 112.

The WF wireless communication section 111 is a circuit that performs communication according to a first wireless communication standard. That is, the WF wireless communication section 111 transmits information according to the first wireless communication standard, or receives information according to the first wireless communication standard. In the present embodiment, specifically, the WF wireless communication section 111 performs wireless communication according to the Wi-Fi (registered trademark) standard.

The BT wireless communication section 112 is a circuit that performs communication according to a second wireless communication standard. That is, the BT wireless communication section 112 transmits information according to the second wireless communication standard, or receives information according to the second wireless communication standard. In the present embodiment, the BT wireless communication section 112 performs Bluetooth communication, which is communication according to the Bluetooth standard. More specifically, in the present embodiment, the BT wireless communication section 112 performs wireless communication according to a Bluetooth Low Energy (BLE) standard, which is a Bluetooth low power consumption standard.

The printing section 120 includes a printing engine which is a mechanical configuration that performs printing on a medium. In the present embodiment, the configuration of the printing section 120 will be described as an ink jet printing configuration, but the printing section 120 may include a printing engine configured to print with a color material (toner) by an electrophotographic method. In addition, the medium is, for example, paper, but may be cloth or the like.

In the present embodiment, the printing section 120 includes, for example, a print head that discharges a coloring material onto a medium, as a printing engine. The print head performs printing by an ink jet method using the supplied coloring material (specifically, ink). The printing engine may include a medium accommodating container that accommodates a medium, a transport mechanism that transports the medium from the medium accommodating container to a position facing the print head, a driving mechanism that drives a carriage including the print head, and the like in addition to the print head. In this case, the printing section 120 prints information such as an image on the medium by ejecting the coloring material from the print head to the medium transported by the transport mechanism.

The printing section 120 may be referred to as a presentation section because the printing section 120 can present the information to the user U in the vicinity of the communication device 100 by printing the information on a medium at the installation location of the communication device 100.

The UI section 130 is a component that functions as a user interface. In the present embodiment, the UI section 130 includes a display. The UI section 130 including the display may be referred to as a presentation section because the UI section 130 can present the information to the user U in the vicinity of the communication device 100 by displaying the information at the installation location of the communication device 100. The UI section 130 may include an input device such as a button or a pointing device that receives an input operation from the user U. The UI section 130 may be a touch panel in which an input device and a display are integrally configured.

The control section 150 controls the operation of the communication device 100. In particular, as a function of establishing a wireless communication connection between the WF wireless communication section 111 of the communication device 100 and the access point AP outside the communication device 100, the control section 150 includes a determination section 151 and a wireless setting section 152 as illustrated in FIG. 2.

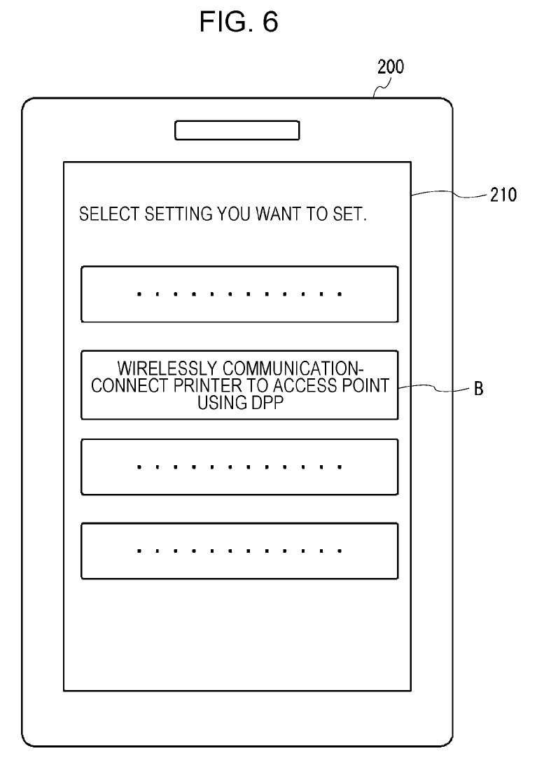

The determination section 151 determines whether the strength of the signal received by the BT wireless communication section 112 from the terminal device 200 is equal to or more than a predetermined threshold. As will be described later, the terminal device 200 sends a signal according to a predetermined wireless communication standard (Bluetooth standard) in response to an instruction from the user U. Specifically, when a button B (refer to FIG. 6) to be described later is operated by the user U, the terminal device 200 sends the signal (that is, the Bluetooth signal). The signal is a signal according to a predetermined format indicating that the signal is a signal sent in response to a specific instruction from the user U, for example. The determination section 151 acquires, for example, a Received Signal Strength Indication (RSSI) of a signal according to a predetermined format among signals received by the BT wireless communication section 112. The determination section 151 compares the RSSI with a predetermined threshold for determining whether the device (that is, the source of the signal) that is the sender of the signal is farther away from the communication device 100 than a predetermined distance.

Generally, as a distance between a signal transmission device and a signal reception device becomes longer, the RSSI of the signal received by the reception device becomes weaker. Therefore, by determining whether the RSSI is equal to or more than the threshold, it is possible to determine whether the device (in this case, the terminal device 200) that is the sender of the signal is farther than the predetermined distance from the communication device 100. That is, by comparing the RSSI with the threshold, it is possible to determine whether the distance between the terminal device 200 and the communication device 100 is equal to or more than a distance that is allowed as the moving distance of the user U. The specific value of the threshold may be, for example, the received signal strength indication of the signal measured by the reception device when the reception device is present at a position separated by a predetermined distance (a distance allowed as a moving distance of the user U) from the signal transmission device. As described above, the determination section 151 determines whether the terminal device 200 is present at a position separated by a predetermined distance or more from the communication device 100 by determining whether the strength of the signal sent from the terminal device 200 is equal to or more than the threshold in accordance with the specific instruction from the user U. That is, when the strength of the received signal is equal to or more than the threshold, the determination section 151 determines that the terminal device 200 is present at a position separated by a predetermined distance or more from the communication device 100. Meanwhile, when the strength of the received signal is less than the threshold, the determination section 151 determines that the terminal device 200 is present at a position less than the predetermined distance from the communication device 100.

The wireless setting section 152 executes processing of performing a wireless setting in the communication device 100. That is, the wireless setting section 152 executes processing for establishing a wireless communication connection between the access point AP and the WF wireless communication section 111. In particular, in the present embodiment, the wireless setting section 152 establishes the wireless communication connection between the access point AP and the WF wireless communication section 111 according to the procedure defined by the DPP (Wi-Fi Easy Connect). Therefore, the wireless setting section 152 acquires the access point information, which is information used to establish the wireless communication connection between the access point AP and the WF wireless communication section 111, from another device (the terminal device 200 in the present embodiment) having the access point information.

In the DPP, the processing of acquiring the access point information includes three phases. Specifically, the processing by which the device that operates as the enrollee obtains the access point information (that is, a Configuration Object) from the device that operates as the configurator includes three phases of Bootstrapping, Authentication, and Configuration.

The Bootstrapping is processing in which the enrollee provides the predetermined information to the configurator. The predetermined information is information necessary for the configurator to start communication with the enrollee in the Authentication, which is the subsequent phase, and specifically includes the Bootstrapping Key defined in the DPP. The Bootstrapping Key is the public key of the Enrollee. That is, the predetermined information is information that needs to be provided to the terminal device 200 so that the terminal device 200 (configurator) starts communication with the communication device 100 according to the predetermined communication procedure for the WF wireless communication section 111 (that is, the enrollee which is the communication device 100) to receive the access point information from the terminal device 200. In other words, the predetermined information is information that the communication device 100 needs to provide to the terminal device 200 in order to enable the terminal device 200 to execute predetermined communication (communication in an Authentication phase, which will be described later). The predetermined information may include information such as a Media Access Control (MAC) address of the communication device 100. Hereinafter, the above-described predetermined information provided from the enrollee to the configurator in the Bootstrapping phase defined by the DPP is also referred to as Bootstrapping information.

As a method of providing the predetermined information in the Bootstrapping, the predetermined information can be provided by communication according to the Bluetooth standard or by a QR code (registered trademark). Meanwhile, the communication between the terminal device 200 and the communication device 100 in the Authentication phase and the Configuration phase is performed according to the Wi-Fi standard. That is, in the Authentication phase and the Configuration phase, the communication device 100 communicates with the terminal device 200 by using the WF wireless communication section 111.

The Authentication is processing in which the configurator (terminal device 200) and the enrollee (communication device 100) authenticate each other and generate a shared key used for encrypting the transmission of the Configuration Object. That is, in this phase, a key for encrypting the access point information is generated. The terminal device 200 and the communication device 100 (wireless setting section 152) respectively generate the shared key based on, for example, Elliptic Curve Diffie-Hellman (ECDH) key exchange. In the Authentication phase, first, the terminal device 200, which is the configurator, transmits a signal called a DPP Authentication Request to the communication device 100, which is the enrollee. The signal includes a message generated by using predetermined information acquired from the communication device 100 in the Bootstrapping phase. Therefore, as described above, the predetermined information is information that is required to be provided to the terminal device 200 in order for the terminal device 200 to start the communication (DPP Authentication Request) according to the predetermined communication procedure with respect to the communication device 100. In the Authentication phase, after the DPP Authentication Request is transmitted, a signal called a DPP Authentication Response is transmitted from the enrollee to the configurator. Finally, a signal called DPP Authentication Confirm is transmitted from the configurator to the enrollee.

The Configuration is processing of transmitting the access point information (Configuration Object) from the configurator to the enrollee by the encrypted communication using the shared key generated in the Authentication phase. Specifically, in the Configuration phase, first, the communication device 100, which is the enrollee, transmits a signal to the terminal device 200, which is the configurator, the signal being referred to as the DPP Configuration Request. Meanwhile, the configurator transmits the signal called the DPP Configuration Response to the enrollee. The DPP Configuration Response includes access point information (Configuration Object).

As described above, in order for the communication device 100 to acquire the access point information from the terminal device 200, the Bootstrapping is required to be performed. That is, it is necessary to provide the Bootstrapping information (predetermined information) from the communication device 100 to the terminal device 200. In recent years, code images such as QR codes are widely used, and many users are familiar with procedures using the code images. Therefore, it is preferable that the Bootstrapping information is provided to the terminal device 200 in a procedure in which the communication device 100 presents the code image including the Bootstrapping information and the terminal device 200 reads the code image by the operation of the user U. Meanwhile, the provision of the Bootstrapping information by the Bluetooth communication according to the BLE standard causes the processing to proceed by the information transmission by the invisible radio wave, and the user U has difficulty in understanding the progress status of the processing. In addition, in order to realize the provision of the Bootstrapping information by the Bluetooth communication according to the BLE standard, there may be a case where the user U needs to perform an unfamiliar permission operation on the terminal device 200 in advance to permit the implementation of the communication. For these reasons, the provision of the Bootstrapping information by Bluetooth communication is inferior to the provision by reading the code image from a user-friendly viewpoint. In such a background, it is desirable that the provision of the Bootstrapping information is basically performed by outputting a code image. However, when the distance from the position of the user, that is, the position of the terminal device 200 to the communication device 100 is long, the user is forced to move a lot to perform the reading of the code image. Therefore, in such a case, it is preferable to provide the Bootstrapping information by the Bluetooth communication. Therefore, in the present embodiment, the wireless setting section 152 switches the method of providing the Bootstrapping information according to the determination result of the determination section 151.

The wireless setting section 152 controls the presentation or transmission of predetermined information (Bootstrapping information) as the processing of the Bootstrapping phase defined by the DPP. The presentation of predetermined information may be the display of predetermined information by the UI section 130 or the printing of predetermined information by the printing section 120. Specifically, when the determination section 151 determines that the strength of the signal received from the terminal device 200 is equal to or more than the threshold, the wireless setting section 152 causes the UI section 130 or the printing section 120 to present predetermined information (Bootstrapping information). Specifically, the wireless setting section 152 generates an image of a two-dimensional code such as a QR code in which predetermined information is encoded, and causes the UI section 130 to play the image. Alternatively, the wireless setting section 152 causes the printing section 120 to print the image of the generated two-dimensional code.

Further, when the determination section 151 determines that the strength of the signal received from the terminal device 200 is less than the threshold, the wireless setting section 152 causes the BT wireless communication section 112 to transmit predetermined information (Bootstrapping information). Therefore, in this case, in the present embodiment, the predetermined information is transmitted to the terminal device 200 by the BLE communication. As a result, the Bootstrapping can be performed without moving the user over a long distance. The BT wireless communication section 112 repeatedly transmits predetermined information (Bootstrapping information) at a predetermined time interval, for example.

As described above, in the present embodiment, the Bootstrapping is performed according to the determination result of the determination section 151. After the bootstrapping is performed, when the WF wireless communication section 111 receives the signal of the Authentication phase from the terminal device 200, the wireless setting section 152 executes the processing of the Authentication phase and the Configuration phase according to the procedure defined in the DPP. As a result, the wireless setting section 152 acquires the access point information from the terminal device 200. When the wireless setting section 152 acquires the access point information, the wireless setting section 152 performs the processing of establishing the wireless communication connection with the access point AP by using the acquired access point information.

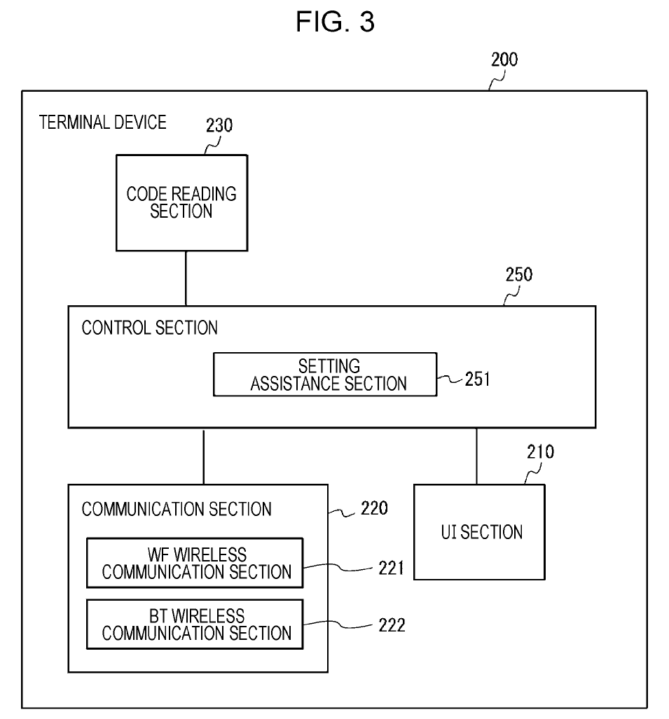

Next, the terminal device 200 will be described. The terminal device 200 is a device carried and operated by the user U, and is, for example, a smartphone, a tablet terminal, a personal computer, or the like. FIG. 3 is a block diagram illustrating an example of the configuration of the terminal device 200. As illustrated in FIG. 3, the terminal device 200 includes a UI section 210, a communication section 220, a code reading section 230, and a control section 250.

The UI section 210 is a component that functions as the user interface. Specifically, the UI section 210 is a user interface device including an input device such as a button or a pointing device that receives an input operation from the user U and a display. The UI section 210 may be a touch panel in which an input device and a display are integrally configured.

The communication section 220 is a hardware circuit that performs wireless communication according to a predetermined communication standard with another device, and may include software such as firmware. The communication section 220 includes a WF wireless communication section 221 and a BT wireless communication section 222.

The WF wireless communication section 221 is a circuit that performs communication according to the first wireless communication standard described above. Specifically, the WF wireless communication section 221 performs the wireless communication according to the Wi-Fi standard.

The BT wireless communication section 222 is a circuit that performs the communication according to the second wireless communication standard described above. In the present embodiment, the BT wireless communication section 222 performs the Bluetooth communication, which is the communication according to the Bluetooth standard. More specifically, in the present embodiment, the BT wireless communication section 222 performs the wireless communication according to the BLE standard.

The code reading section 230 is a reader that reads a code image such as a QR code. The code reading section 230 includes, for example, a camera as hardware for reading, but may also include a scanner. The code reading section 230 decodes the captured or scanned code image to read the information represented by the code image. Therefore, the code reading section 230 can read the code image of the Bootstrapping information presented (displayed or printed) by the communication device 100.

The control section 250 controls the operation of the terminal device 200. As illustrated in FIG. 3, the control section 250 includes a setting assistance section 251.

The setting assistance section 251 executes the processing of assisting in setting of the wireless communication in the communication device 100. In particular, the setting assistance section 251 executes predetermined processing for transmitting the access point information to the communication device 100. In the present embodiment, the setting assistance section 251 transmits the access point information to the communication device 100 by using the WF wireless communication section 221 according to the procedure defined in the DPP. Specifically, the setting assistance section 251 starts the predetermined processing for transmitting the access point information to the communication device 100 in response to the code reading section 230 reading the code image including the Bootstrapping information or in response to the BT wireless communication section 222 receiving the Bootstrapping information. That is, when the terminal device 200 acquires the predetermined information (Bootstrapping information) provided from the communication device 100, the setting assistance section 251 starts the processing of the Authentication phase of the DPP. Thereafter, the setting assistance section 251 executes the processing of the Configuration phase of the DPP, and thus transmits the access point information to the communication device 100.

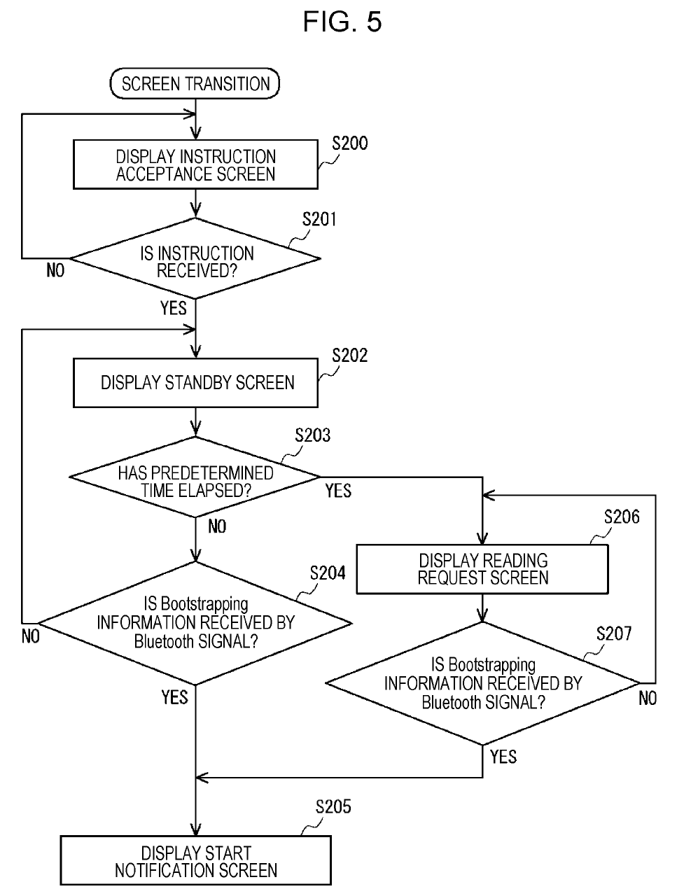

Further, in the present embodiment, the setting assistance section 251 performs processing of displaying a UI screen (user interface screen) for assisting the wireless setting in the communication device 100 on the UI section 210. For the assistance of the wireless setting in the communication device 100, the details of the UI screen displayed on the UI section 210 of the terminal device 200 will be described later with reference to FIGS. 5 to 9. Further, the setting assistance section 251 causes the BT wireless communication section 222 to send a predetermined Bluetooth signal in response to the fact that a specific instruction to be described later is received. This signal is used to determine the distance between the communication device 100 and the terminal device 200.

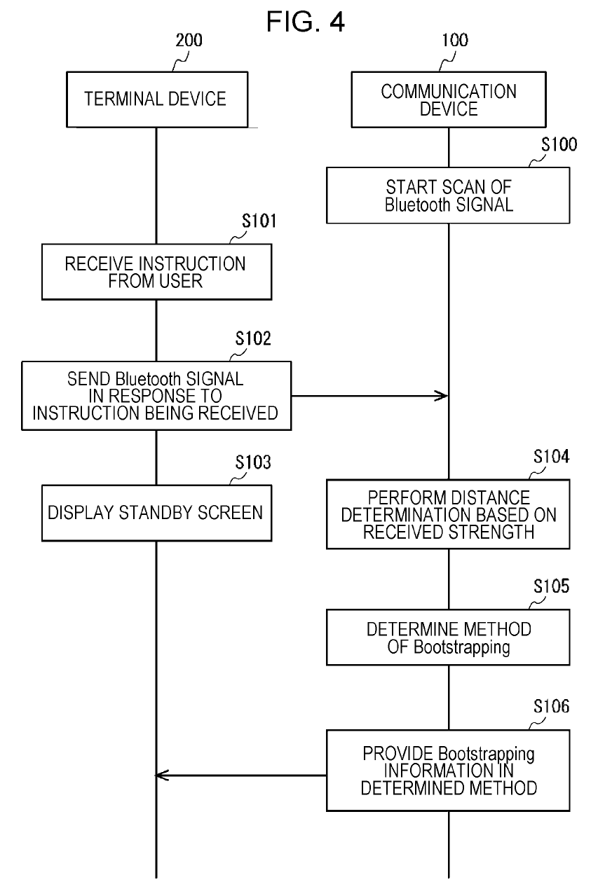

Next, a flow of the processing until the Bootstrapping information is provided from the communication device 100 to the terminal device 200 will be described. FIG. 4 is a sequence chart illustrating an example of a flow of processing until the Bootstrapping information is provided. Hereinafter, the flow of the processing will be described with reference to FIG. 4.

In Step S100, the wireless setting section 152 of the communication device 100 starts the BT wireless communication section 112 to scan for a Bluetooth signal. The wireless setting section 152 starts the BT wireless communication section 112 to scan the Bluetooth signal when, for example, the wireless connection setting of the communication device 100 has not been performed yet, that is, when the communication device 100 is in a state where the wireless communication connection has not been established with the access point AP yet.

Next, in Step S101, the setting assistance section 251 of the terminal device 200 receives a specific instruction from the user U. This specific instruction is, for example, an instruction to perform wireless communication connection between the communication device 100 and the access point AP by using DPP, and is received by the setting assistance section 251 when the user U presses, for example, a button B (refer to FIG. 6) described later.

In Step S102, the setting assistance section 251 of the terminal device 200 causes the BT wireless communication section 222 to send a predetermined Bluetooth signal in response to the above-described instruction being received. As a result, the BT wireless communication section 222 sends a predetermined signal according to the Bluetooth standard. For example, the signal is a signal of a predetermined format for notifying the device that has received the signal that the above-described instruction is received, that is, the above-described instruction is input to the terminal device 200. The signal transmitted in this step may be a beacon signal according to the BLE standard.

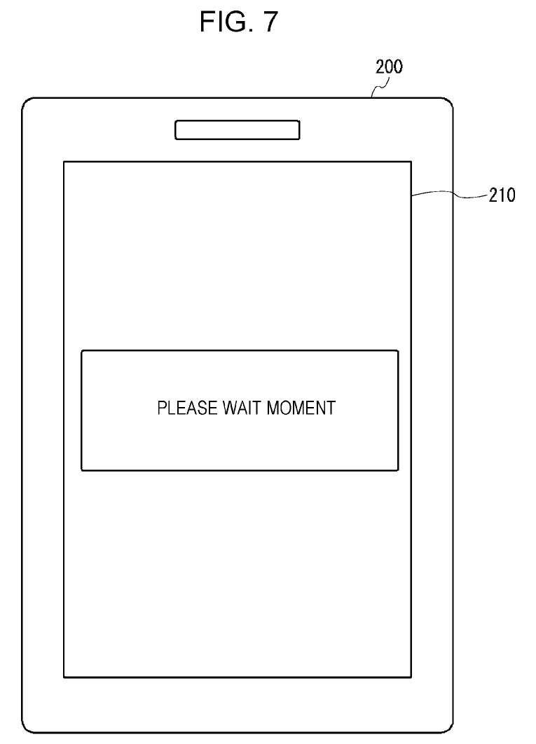

Further, in Step S103, the setting assistance section 251 of the terminal device 200 causes the UI section 210 of the terminal device 200 to display a predetermined standby screen (refer to FIG. 7) in response to the above-described instruction being received. As a result, the UI section 210 displays the standby screen. In the sequence chart illustrated in FIG. 4, the steps are illustrated such that the Step S103 is performed after the Step S102. However, the steps may be performed in the reverse order or at the same time.

Meanwhile, when the BT wireless communication section 112 of the communication device 100 receives the signal sent in Step S102, in Step S104, the determination section 151 of the communication device 100 performs the distance determination based on the strength of the received signal. That is, the determination section 151 determines whether the terminal device 200 is present at a position separated by a predetermined distance or more from the communication device 100 by determining whether the strength of the received signal is equal to or more than the threshold.

Next, in Step S105, the wireless setting section 152 of the communication device 100 determines the method of Bootstrapping based on the determination result in Step S104. That is, when it is determined that the strength of the received signal is equal to or more than the threshold, the wireless setting section 152 determines to provide the information to the terminal device 200 by causing the UI section 130 or the printing section 120 to present the Bootstrapping information. Meanwhile, when it is determined that the strength of the received signal is less than the threshold, the wireless setting section 152 determines to provide the Bootstrapping information to the terminal device 200 by causing the BT wireless communication section 112 to transmit the Bootstrapping information.

Thereafter, in Step S106, the communication device 100 provides the Bootstrapping information to the terminal device 200 in the method determined in Step S105. When the terminal device 200 reads the code image including the Bootstrapping information or the terminal device 200 receives the Bootstrapping information by the BLE communication, the processing of the Bootstrapping phase is ended. When the terminal device 200 acquires the Bootstrapping information, the setting assistance section 251 of the terminal device 200 starts the communication according to the communication procedure defined by the DPP using the WF wireless communication section 221. That is, the setting assistance section 251 starts the communication in the Authentication phase.

Next, the UI screen for assisting the wireless setting in the communication device 100 displayed on the terminal device 200 will be described. FIG. 5 is a flowchart illustrating a flow of transition of the UI screens displayed on the terminal device 200. Hereinafter, the transition of the UI screen for assisting the wireless setting in the communication device 100 will be described with reference to FIG. 5.

First, in Step S200, the setting assistance section 251 causes the UI section 210 to display an instruction acceptance screen for receiving an instruction from the user. FIG. 6 is a schematic diagram illustrating an example of an instruction acceptance screen displayed by the UI section 210 of the terminal device 200. In the example illustrated in FIG. 6, the instruction acceptance screen includes the button B for instructing to use the DPP to wirelessly communication-connect the communication device 100 to the access point AP. The processing proceeds to Step S201 in a state where the instruction acceptance screen is displayed.

Next, in Step S201, the setting assistance section 251 determines whether the above-described instruction is received. That is, the setting assistance section 251 determines whether the user U has operated (pressed) the button B. The instruction acceptance screen is displayed until the button B is operated. However, when an operation other than the button B is performed, the screen may transition from the instruction acceptance screen to any screen according to the operation. When the button B is operated, the processing proceeds to Step S202. As described with reference to the sequence chart of FIG. 4, when the button B is operated, the setting assistance section 251 causes the BT wireless communication section 222 to send a predetermined Bluetooth signal. As described above, the signal is used to determine the distance between the communication device 100 and the terminal device 200.

In Step S202, the setting assistance section 251 causes the UI section 210 to display the standby screen instructing the user to stand by. FIG. 7 is a schematic diagram illustrating an example of the standby screen displayed by the UI section 210 of the terminal device 200. The processing proceeds to Step S203 in a state where the standby screen is displayed.

In Step S203, the setting assistance section 251 determines whether a predetermined time (for example, 30 seconds) has elapsed after sending the above-described signal sent in response to the operation of the button B. When the predetermined time has not elapsed since the signal is sent, the processing proceeds to Step S204. Meanwhile, when a predetermined time elapses after the signal is sent, the processing proceeds to Step S206.

In Step S204, the setting assistance section 251 determines whether the Bootstrapping information transmitted from the communication device 100 is received. As described above, when it is determined that the terminal device 200 is present far from the communication device 100, the communication device 100 transmits the Bluetooth signal including the Bootstrapping information. Therefore, in such a case, the terminal device 200 receives the Bootstrapping information transmitted from the communication device 100. Meanwhile, when it is determined that the terminal device 200 is present closer to the communication device 100 than a predetermined distance, the communication device 100 does not transmit the Bluetooth signal including the Bootstrapping information, and displays or prints the code image including the information. Therefore, in such a case, the terminal device 200 does not receive the Bootstrapping information transmitted from the communication device 100. When the BT wireless communication section 222 of the terminal device 200 receives a signal including the Bootstrapping information, the processing proceeds to Step S205. When the BT wireless communication section 222 of the terminal device 200 does not receive the signal including the Bootstrapping information, the processing returns to Step S202, and the display of the standby screen continues.

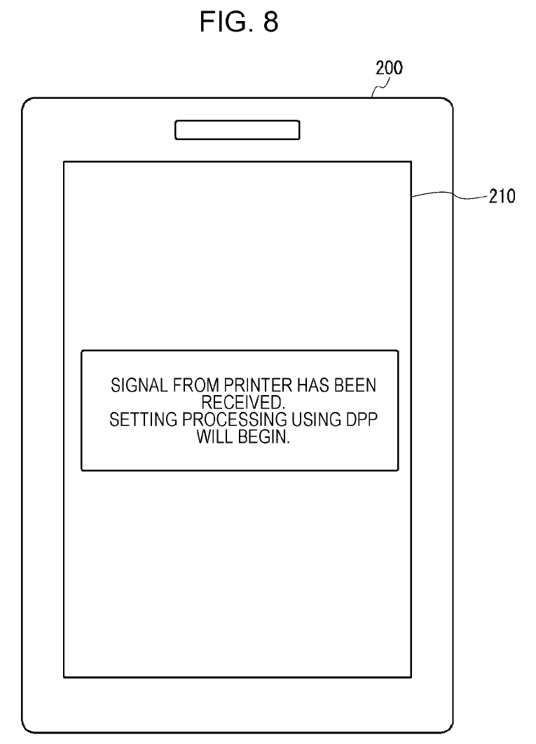

In Step S205, the setting assistance section 251 causes the UI section 210 to display a start notification screen for notifying the user that the processing of establishing the wireless communication connection between the communication device 100 and the access point AP is started. FIG. 8 is a schematic diagram illustrating an example of the start notification screen displayed by the UI section 210 of the terminal device 200. As described above, in the present embodiment, the setting assistance section 251 of the terminal device 200 notifies the user that the processing for establishing the wireless communication connection between the communication device 100 and the access point AP is started in response to the reception of the Bootstrapping information transmitted from the communication device 100. As a result, the user can recognize that the connection processing is appropriately proceeding.

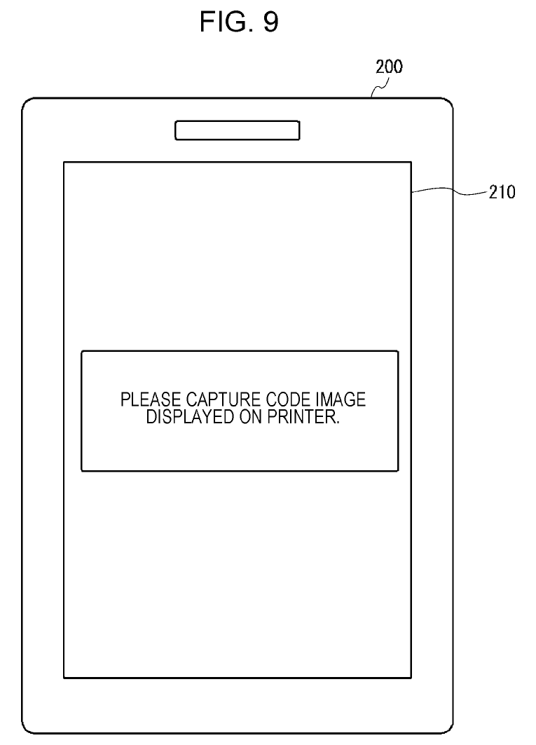

Meanwhile, when the terminal device 200 does not receive the signal including the Bootstrapping information for a predetermined time, in Step S206, the setting assistance section 251 causes the UI section 210 to display the reading request screen. The reading request screen is a screen for requesting the user U to read the code image (Bootstrapping information) presented by the communication device 100. FIG. 9 is a schematic diagram illustrating an example of a reading request screen displayed by the UI section 210 of the terminal device 200. As described above, in the present embodiment, the setting assistance section 251 of the terminal device 200 performs a notification for prompting the user to take an action of reading the Bootstrapping information presented by the communication device 100 by the terminal device 200 when the terminal device 200 does not receive the Bootstrapping information for a predetermined time. As a result, it is possible to reliably complete the Bootstrapping by reading the code image.

Due to communication congestion or the like, the terminal device 200 may rarely receive the Bootstrapping information transmitted from the communication device 100 after a predetermined time has elapsed. In order to correspond to such a case, as illustrated in FIG. 5, the processing may proceed to Step S207 in a state where the reading request screen is displayed. In Step S207, the same processing as in Step S204 is performed. When the terminal device 200 receives the signal including the Bootstrapping information, the processing proceeds to Step S205, and the UI section 210 displays a start notification screen as illustrated in FIG. 8. When the terminal device 200 does not receive the signal including the Bootstrapping information, the processing returns to Step S206, and the reading request screen as illustrated in FIG. 9 continues.

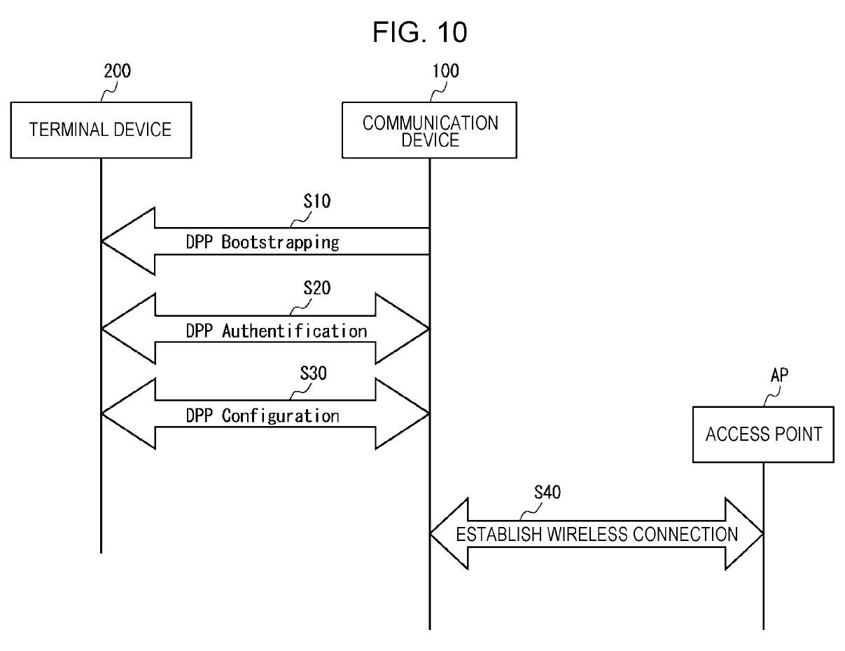

Next, a flow of an operation of the communication device 100 establishing a wireless connection with the access point AP will be described. FIG. 10 is a sequence chart illustrating an example of a flow of the operation of the communication device 100 establishing wireless connection with the access point AP. Hereinafter, the flow of the operation will be described with reference to FIG. 10.

In Step S10, as described above, the processing of the Bootstrapping phase of the DPP is performed, and predetermined information (Bootstrapping information) is provided from the communication device 100 to the terminal device 200.

Next, in Step S20, the processing of the Authentication phase of the DPP is performed between the terminal device 200 and the communication device 100. As a result, a key for transmitting the access point information from the encrypted communication is generated.

Next, in Step S30, the processing of the Configuration phase of the DPP is performed between the terminal device 200 and the communication device 100. As a result, the access point information is transmitted from the terminal device 200 to the communication device 100.

Thereafter, in Step S40, the communication device 100 establishes a wireless connection (Wi-Fi standard-based wireless communication connection) with the access point AP by using the access point information. In other words, in Step S40, the communication device 100 participates in the LAN using the access point AP by using the access point information.

As described above, in the present embodiment, the predetermined information (Bootstrapping information) is provided in a method according to the determination result of the determination section 151. Therefore, it is possible to appropriately switch between a method preferred from a user-friendly point of view (that is, presentation of the code image) and a method preferred from a point of view of reducing the burden of the user's movement (that is, transmission of the predetermined information). Therefore, according to the present embodiment, it is possible to realize a wireless setting method that is easy to use for the user.

### Modification Example of Embodiment

Next, a modification example of the embodiment will be described. In the above-described embodiment, the wireless setting section 152 of the communication device 100 determines the method of Bootstrapping by using only the distance between the communication device 100 and the terminal device 200 estimated from the strength of the received signal. However, the wireless setting section 152 may determine the method of Bootstrapping by using other information. Hereinafter, as a modification example, an example in which the method of Bootstrapping is determined using other information will be specifically described.

For example, the processing of the three phases of the DPP described above may be performed between the terminal device 200 and the access point AP before the processing of the three phases of the DPP described above is performed between the terminal device 200 and the communication device 100. Here, the processing of the three phases of the DPP refers to the processing including Bootstrapping, Authentication, and Configuration defined by the DPP. In the processing of the three phases of the DPP performed between the terminal device 200 and the access point AP, the Configuration Object is transmitted from the terminal device 200 to the access point AP. The Configuration Object transmitted from the terminal device 200 to the access point AP is information referred to by the access point AP when the communication device 100 that has acquired the access point information from the terminal device 200 and the access point AP establish a wireless connection. The Configuration Object transmitted from the terminal device 200 to the access point AP may be referred to as reference information. As described above, the terminal device 200 can perform the processing of the three phases of the DPP with not only the communication device 100 but also the access point AP. In such a case, the terminal device 200 needs to acquire the Bootstrapping information from the access point AP and the Bootstrapping information from the communication device 100. Here, when the acquisition methods are different from each other, the user may have a complicated impression of the procedure or may be confused. Therefore, for the user, it is preferable that the acquisition methods are unified. Therefore, in the present modification example, particularly, a communication device that can appropriately determine which method to use to provide the Bootstrapping information from the communication device 100 when the two pieces of Bootstrapping information are acquired by a unified method will be described. That is, in the present modification example, a communication device that can appropriately determine whether to acquire the two pieces of Bootstrapping information in the terminal device 200 in either the combination of the first provision and the combination of the second provision will be described. Here, the combination of the first provision is a combination in which the Bootstrapping information from the access point AP and the Bootstrapping information from the communication device 100 are provided as a code image. In addition, the second combination of the provision is a combination in which the Bootstrapping information from the access point AP and the Bootstrapping information from the communication device 100 are provided by the Bluetooth communication (BLE communication).

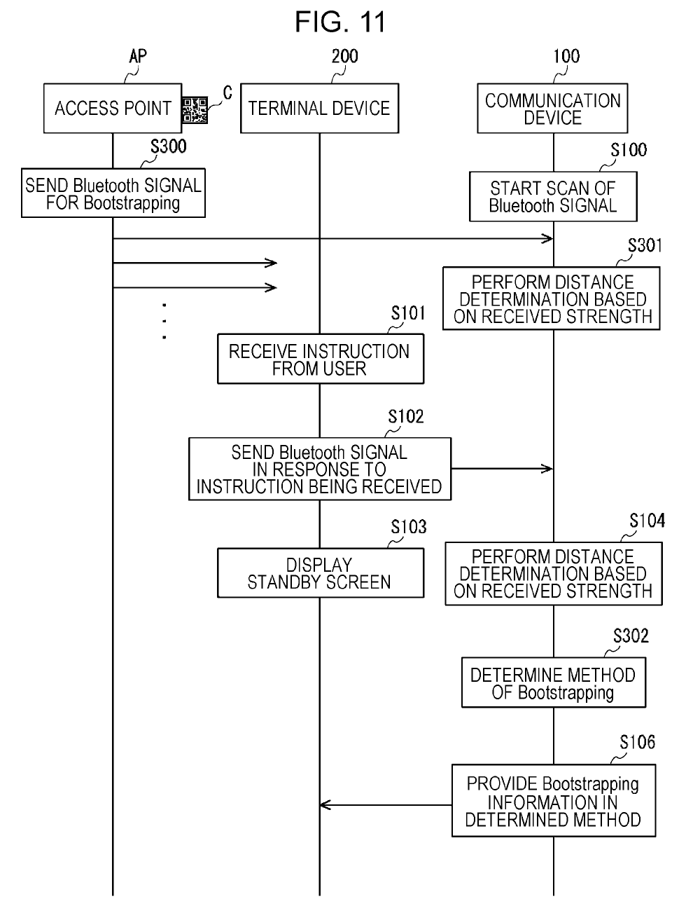

FIG. 11 is a sequence chart illustrating an example of a flow of processing until the communication device 100 provides the Bootstrapping information in the modification example. In the present modification example, as illustrated in FIG. 11, it is assumed that a code image C such as a QR code in which the Bootstrapping information of the access point AP is encoded is attached to the access point AP. In addition, as illustrated in Step S300 of FIG. 11, the access point AP repeatedly sends the Bluetooth signal including the Bootstrapping information at a predetermined time interval. As described above, the access point AP is in a state where the Bootstrapping information can be provided by the code image or the Bluetooth signal.

The sequence chart illustrated in FIG. 11 is different from the sequence chart illustrated in FIG. 4 in that Step S300 and Step S301 are added and Step S105 is replaced with Step S302. Hereinafter, a flow of determining the method of providing the Bootstrapping information in the modification example will be described with reference to FIG. 11.

In Step S100, the wireless setting section 152 of the communication device 100 that has not yet established the wireless communication connection with the access point AP starts the BT wireless communication section 112 to scan the Bluetooth signal. Further, as described above, in Step S300, the access point AP repeatedly sends the Bluetooth signal including the Bootstrapping information.

When the BT wireless communication section 112 of the communication device 100 receives the Bluetooth signal from the access point AP, in Step S301, the determination section 151 of the communication device 100 performs a distance determination based on the strength of the received signal. That is, the determination section 151 determines whether the access point AP is present at a position separated by a predetermined distance or more from the communication device 100 by determining whether the strength of the received signal is equal to or more than the threshold. In addition, the processing of this step may be performed at the same timing as that of Step S104 in which the determination of the distance between the terminal device 200 and the communication device 100 is performed, or may be performed after the execution timing of Step S104 in which the determination of the distance between the terminal device 200 and the communication device 100 is performed.

Further, in Step S101, when the setting assistance section 251 of the terminal device 200 receives an instruction from the user U to wirelessly communication-connect the communication device 100 to the access point AP by using the DPP, in Step S102, the setting assistance section 251 causes the BT wireless communication section 222 to send the Bluetooth signal. In Step S103, the setting assistance section 251 of the terminal device 200 causes the UI section 210 of the terminal device 200 to display a predetermined standby screen in response to the above-described instruction being received.

When the BT wireless communication section 112 of the communication device 100 receives the signal sent in Step S102, in Step S104, the determination section 151 of the communication device 100 performs the distance determination based on the strength of the signal received from the terminal device 200. That is, the determination section 151 determines whether the terminal device 200 is present at a position separated by a predetermined distance or more from the communication device 100 by determining whether the strength of the received signal is equal to or more than the threshold.

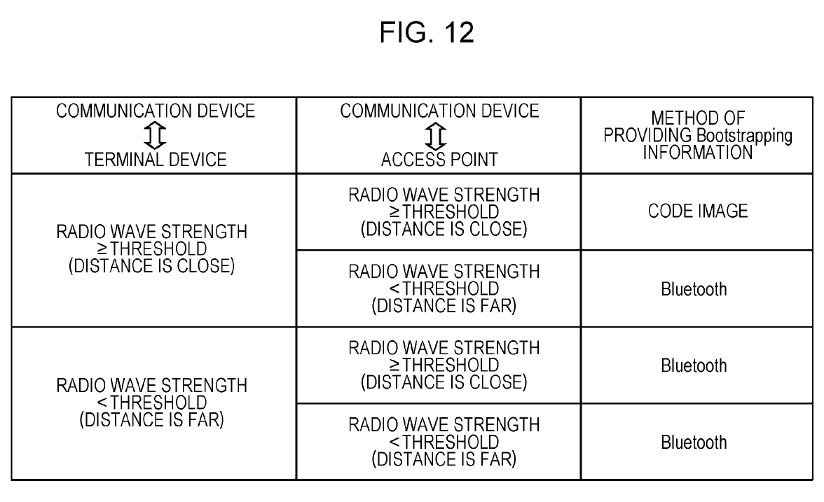

Next, in Step S302, the wireless setting section 152 of the communication device 100 determines the method of Bootstrapping based on the determination result in Step S301 and the determination result in Step S104. The determination in this step will be described later with reference to FIG. 12. After Step S302, in Step S106, the communication device 100 provides the Bootstrapping information to the terminal device 200 in the method determined in Step S302.

FIG. 12 is a table summarizing the relationship between the determination result and the determined method of Bootstrapping in the modification example. In the present modification example, when it is determined that the strength (hereinafter, also referred to as a first strength) of the signal from the terminal device 200 is equal to or more than the threshold and the strength (hereinafter, also referred to as a second strength) of the signal from the access point AP is equal to or more than the threshold, the wireless setting section 152 determines to provide the Bootstrapping information by the code image. That is, when the terminal device 200 is close to the communication device 100 and the access point AP is also close to the communication device 100, the wireless setting section 152 determines to provide the information to the terminal device 200 by causing the UI section 130 or the printing section 120 to present the Bootstrapping information. Therefore, in this case, the user U reads the code image of the access point AP and reads the code image presented by the communication device 100. When the code image of the access point AP is read, the setting assistance section 251 executes the processing of the three phases of the DPP between the setting assistance section 251 and the access point AP. When the code image of the communication device 100 is read, the setting assistance section 251 executes the processing of the three phases of the DPP between the setting assistance section 251 and the communication device 100. In the present modification example, the setting assistance section 251 of the terminal device 200 may display, on the UI section 210, a screen for requesting the user U to read the code image of the access point AP and the code image presented by the communication device 100 as the reading request screen.

In addition, as illustrated in FIG. 12, in the present modification example, when at least one of the signal strength (first strength) from the terminal device 200 and the signal strength (second strength) from the access point AP is determined to be less than the threshold, the wireless setting section 152 makes the following determination. That is, in this case, the wireless setting section 152 determines to provide the information to the terminal device 200 by causing the BT wireless communication section 112 to transmit the Bootstrapping information. That is, when it is determined that at least one of the distance between the terminal device 200 and the communication device 100 and the distance between the access point AP and the communication device 100 is longer than the predetermined distance, the wireless setting section 152 determines to provide the Bootstrapping information to the terminal device 200 by the Bluetooth signal. In such a case, when the user U is requested to read the two code images, the user U may go to the access point AP to read the code image of the access point AP, and then, when the user U reads the code image of the communication device 100, the user U may be moved to a long distance. Therefore, in such a case, the wireless setting section 152 provides the Bootstrapping information to the terminal device 200 in a manner that does not require the user U to move. In the present modification example, when the setting assistance section 251 of the terminal device 200 receives the Bluetooth signal including the Bootstrapping information from the communication device 100, the setting assistance section 251 performs, for example, the following processing. In this case, the setting assistance section 251 receives the Bluetooth signal including the Bootstrapping information repeatedly transmitted from the access point AP, and executes the processing of the three phases of the DPP between the setting assistance section 251 and the access point AP by using the information. Thereafter, the setting assistance section 251 executes the processing of the three phases of the DPP between the setting assistance section 251 and the communication device 100 by using the Bootstrapping information received from the communication device 100.

As described above, in the present modification example, the determination section 151 of the communication device 100 further determines whether the strength of the signal received by the BT wireless communication section 112 from the access point AP is equal to or more than the threshold. The wireless setting section 152 of the communication device 100 determines whether to present the Bootstrapping information or to transmit the Bootstrapping information by the BT wireless communication section 112 by using the determination result of whether the signal received from the access point AP has the strength equal to or more than the threshold in addition to the determination result of whether the signal received from the terminal device 200 has the strength equal to or more than the threshold. More specifically, when it is determined that both the first strength and the second strength are equal to or more than the threshold, the wireless setting section 152 causes the UI section 130 or the printing section 120 to present the Bootstrapping information. Meanwhile, when it is determined that at least one of the first strength and the second strength is less than the threshold, the wireless setting section 152 causes the BT wireless communication section 112 to transmit the Bootstrapping information. Here, the first strength is the strength of the signal received by the communication device 100 from the terminal device 200, and the second strength is the strength of the signal received by the communication device 100 from the access point AP. According to such a configuration, even when it is necessary to acquire the two pieces of Bootstrapping information, it is possible to realize the wireless setting method considering the burden of the movement of the user.

In the above-described modification example, the determination section 151 uses the strength of the Bluetooth signal including the Bootstrapping information sent by the access point AP in order to determine the distance between the communication device 100 and the access point AP. However, when the access point AP sends another Bluetooth signal, the determination section 151 may determine the distance between the communication device 100 and the access point AP by using the strength of such a signal. In addition, the determination section 151 may perform the determination processing based on the strength of the beacon signal according to the BLE standard sent from the access point AP.

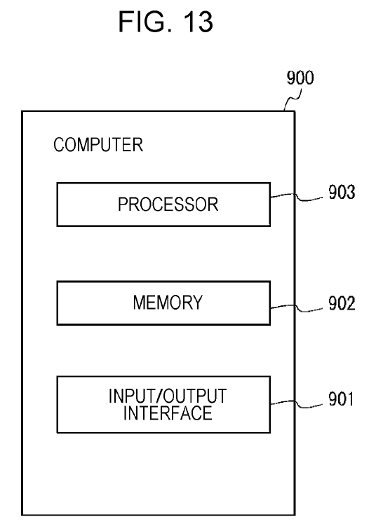

Above, the embodiment and the modification example are described, but the processing of the communication device 100, the terminal device 200, and the access point AP may be executed by a computer included in each device. The computer may be configured as a system on a chip (SoC). FIG. 13 is a block diagram illustrating an example of a hardware configuration of the communication device 100, the terminal device 200, or the computer 900 included in the access point AP. As illustrated in FIG. 13, the computer 900 includes, for example, an input/output interface 901, a memory 902, and a processor 903.

The input/output interface 901 is used to communicate with any circuit or device.

The memory 902 is configured by, for example, a combination of a volatile memory and a non-volatile memory. The memory 902 is used to store a program executed by the processor 903, data used for various processes, and the like.

The processor 903 reads a program from the memory 902 and executes the program to perform various processing described in the above-described embodiment or modification example. The processor 903 may be, for example, a microprocessor, a microprocessor unit (MPU), a central processing unit (CPU), or the like. Further, the processor 903 may include a plurality of processors.

When the program is read by a computer, the program includes a group of commands (or software code) for causing the computer to perform one or more functions described in the embodiment. The program may be stored in a non-transitory computer-readable medium or a storage medium having a physical entity. As a non-limiting example, the computer-readable medium or the storage medium having a physical entity includes a random-access memory (RAM), a read-only memory (ROM), a flash memory, a solid-state drive (SSD) or other memory technology, a CD-ROM, a digital versatile disk (DVD), a Blu-ray (registered trademark) disk, or other optical disk storage, a magnetic cassette, a magnetic tape, a magnetic disk storage, or other magnetic storage device. The program may be transmitted on a temporary computer-readable medium or a communication medium. As a non-limiting example, the temporary computer-readable medium or communication medium includes a propagating signal in an electrical, optical, acoustic, or other form.

The present disclosure is not limited to the above embodiments, and can be appropriately changed without departing from the gist.

Some or all of the above-described embodiments may also be described as, but not limited to, the following Supplementary Notes.

### Supplementary Note 1

An information processing system including:

a communication device; and

a terminal device carried by a user and configured to send a signal according to a predetermined wireless communication standard in response to an instruction from the user, in which

the communication device includes

a first wireless communication section that performs communication according to a first wireless communication standard,

a second wireless communication section that performs communication according to a second wireless communication standard which is the predetermined wireless communication standard,

a presentation section that presents information,

a determination section that determines whether a strength of the signal received by the second wireless communication section from the terminal device is equal to or more than a predetermined threshold, and

a wireless setting section that, when it is determined that the strength is equal to or more than the threshold, causes the presentation section to present predetermined information, and, when it is determined that the strength is less than the threshold, causes the second wireless communication section to transmit the predetermined information, and

the predetermined information is information that is required to be provided to the terminal device in order for the terminal device to start communication according to a predetermined communication procedure for the first wireless communication section to receive access point information which is information used to establish a wireless communication connection between an access point and the first wireless communication section from the terminal device.

### Supplementary Note 2

The information processing system according to Supplementary Note 1, in which

the terminal device includes a setting assistance section that notifies a user that processing for establishing a wireless communication connection between the communication device and the access point is started in response to reception of the predetermined information transmitted from the communication device.

### Supplementary Note 3

The information processing system according to Supplementary Note 1 or 2, in which

the terminal device includes a setting assistance section that performs a notification for prompting a user to take an action of causing the terminal device to read the predetermined information presented by the communication device when a predetermined time elapses after the terminal device sends the signal without receiving the predetermined information.

### Supplementary Note 4

The information processing system according to any one of Supplementary Notes 1 to 3, in which

the determination section further determines whether a strength of a signal received by the second wireless communication section from the access point is equal to or more than the threshold, and

the wireless setting section determines whether to cause the presentation section to present the predetermined information or to cause the second wireless communication section to transmit the predetermined information by using a determination result of whether the strength of the signal received from the access point is equal to or more than the threshold in addition to a determination result of whether the strength of the signal received from the terminal device is equal to or more than the threshold.

### Supplementary Note 5

The information processing system according to Supplementary Note 4, in which

the wireless setting section, when it is determined that both a first strength and a second strength are equal to or more than the threshold, causes the presentation section to present the predetermined information and causes, when it is determined that at least one of the first strength and the second strength is less than the threshold, the second wireless communication section to transmit the predetermined information,

the first strength is the strength of the signal received from the terminal device, and

the second strength is the strength of the signal received from the access point.

### Supplementary Note 6

The information processing system according to any one of Supplementary Notes 1 to 5, in which

the predetermined information is information provided from an enrollee to a configurator in a Bootstrapping phase defined by a Device Provisioning Protocol (DPP).

### Supplementary Note 7

A communication device including:

a first wireless communication section that performs communication according to a first wireless communication standard;

a second wireless communication section that performs communication according to a second wireless communication standard;

a presentation section that presents information;

a determination section that determines whether a strength of a signal received by the second wireless communication section from a terminal device carried by a user is equal to or more than a predetermined threshold; and

a wireless setting section that, when it is determined that the strength is equal to or more than the threshold, causes the presentation section to present predetermined information, and, when it is determined that the strength is less than the threshold, causes the second wireless communication section to transmit the predetermined information, in which

the predetermined information is information that is required to be provided to the terminal device in order for the terminal device to start communication according to a predetermined communication procedure for the first wireless communication section to receive access point information, which is information used to establish a wireless communication connection between an access point and the first wireless communication section, from the terminal device.

### Supplementary Note 8

A processing method for a communication device including a first wireless communication section that performs communication according to a first wireless communication standard, a second wireless communication section that performs communication according to a second wireless communication standard, and a presentation section that presents information, the method including:

determining whether a strength of a signal received from a terminal device carried by a user by the second wireless communication section is equal to or more than a predetermined threshold;

when it is determined that the strength is equal to or more than the threshold, causing the presentation section to present predetermined information; and

when it is determined that the strength is less than the threshold, causing the second wireless communication section to transmit the predetermined information, in which the predetermined information is information that is required to be provided to the terminal device in order for the terminal device to start communication according to a predetermined communication procedure for the first wireless communication section to receive access point information, which is information used to establish a wireless communication connection between an access point and the first wireless communication section, from the terminal device.

What is claimed is:

1. An information processing system comprising:
a communication device; and
a terminal device carried by a user and configured to send a signal according to a predetermined wireless communication standard in response to an instruction from the user, wherein
the communication device includes
a first wireless communication section that performs communication according to a first wireless communication standard,
a second wireless communication section that performs communication according to a second wireless communication standard which is the predetermined wireless communication standard,
a presentation section that presents information,
a determination section that determines whether a strength of the signal received by the second wireless communication section from the terminal device is equal to or more than a predetermined threshold, and
a wireless setting section that, when it is determined that the strength is equal to or more than the threshold, causes the presentation section to present predetermined information, and, when it is determined that the strength is less than the threshold, causes the second wireless communication section to transmit the predetermined information, and
the predetermined information is information that is required to be provided to the terminal device in order for the terminal device to start communication according to a predetermined communication procedure for the first wireless communication section to receive access point information which is information used to establish a wireless communication connection between an access point and the first wireless communication section from the terminal device.

2. The information processing system according to claim 1, wherein
the terminal device includes a setting assistance section that notifies a user that processing for establishing a wireless communication connection between the communication device and the access point is started in response to reception of the predetermined information transmitted from the communication device.

3. The information processing system according to claim 1, wherein
the terminal device includes a setting assistance section that performs a notification for prompting a user to take an action of causing the terminal device to read the predetermined information presented by the communication device when a predetermined time elapses after the terminal device sends the signal without receiving the predetermined information.

4. The information processing system according to claim 1, wherein
the determination section further determines whether a strength of a signal received by the second wireless communication section from the access point is equal to or more than the threshold, and
the wireless setting section determines whether to cause the presentation section to present the predetermined information or to cause the second wireless communication section to transmit the predetermined information by using a determination result of whether the strength of the signal received from the access point is equal to or more than the threshold in addition to a determination result of whether the strength of the signal received from the terminal device is equal to or more than the threshold.

5. The information processing system according to claim 4, wherein
the wireless setting section, when it is determined that both a first strength and a second strength are equal to or more than the threshold, causes the presentation section to present the predetermined information and causes, when it is determined that at least one of the first strength and the second strength is less than the threshold, the second wireless communication section to transmit the predetermined information,
the first strength is the strength of the signal received from the terminal device, and
the second strength is the strength of the signal received from the access point.

6. The information processing system according to claim 1, wherein
the predetermined information is information provided from an enrollee to a configurator in a Bootstrapping phase defined by a Device Provisioning Protocol (DPP).

7. A communication device comprising:
a first wireless communication section that performs communication according to a first wireless communication standard;
a second wireless communication section that performs communication according to a second wireless communication standard;
a presentation section that presents information;
a determination section that determines whether a strength of a signal received by the second wireless communication section from a terminal device carried by a user is equal to or more than a predetermined threshold; and
a wireless setting section that, when it is determined that the strength is equal to or more than the threshold, causes the presentation section to present predetermined information, and, when it is determined that the strength is less than the threshold, causes the second wireless communication section to transmit the predetermined information, wherein
the predetermined information is information that is required to be provided to the terminal device in order for the terminal device to start communication according to a predetermined communication procedure for the first wireless communication section to receive access point information, which is information used to establish a wireless communication connection between an access point and the first wireless communication section, from the terminal device.

8. A processing method for a communication device including a first wireless communication section that performs communication according to a first wireless communication standard, a second wireless communication section that performs communication according to a second wireless communication standard, and a presentation section that presents information, the method comprising:
determining whether a strength of a signal received from a terminal device carried by a user by the second wireless communication section is equal to or more than a predetermined threshold;
when it is determined that the strength is equal to or more than the threshold, causing the presentation section to present predetermined information; and
when it is determined that the strength is less than the threshold, causing the second wireless communication section to transmit the predetermined information, wherein
the predetermined information is information that is required to be provided to the terminal device in order for the terminal device to start communication according to a predetermined communication procedure for the first wireless communication section to receive access point information, which is information used to establish a wireless communication connection between an access point and the first wireless communication section, from the terminal device.
